(19) United States
(12) Patent Application Publication
(10) Pub. No.: US 2024/0346321 A1
(43) Pub. Date: Oct. 17, 2024

(54) ARTIFICIAL NEURAL NETWORK TRAINING FOR MEAN TIME TO FAILURE PREDICTIONS

(71) Applicant: Micron Technology, Inc., Boise, ID (US)

(72) Inventors: Febin Sunny, Folsom, CA (US); Poorna Kale, Folsom, CA (US); Saideep Tiku, Fort Collins, CO (US)

(21) Appl. No.: 18/632,708

(22) Filed: Apr. 11, 2024

Related U.S. Application Data
(60) Provisional application No. 63/459,809, filed on Apr. 17, 2023.

(51) Int. Cl. G06N 3/084

(52) U.S. Cl. CPC G06N 3/084

(57) ABSTRACT

Training an artificial neural network (ANN) can include receiving device design parameters corresponding to a device and operation parameters corresponding to the device. Device throughput characteristics can also be received from a physics solver. Device throughput predictions can be generated utilizing the device design parameters, the operation parameters, and an artificial neural network. A loss gradient can be generated utilizing the device throughput characteristics and the device throughput predictions. The ANN can be trained, utilizing the loss gradient, to generate different device throughput predictions.

### PRIORITY INFORMATION

This Application claims the benefits of U.S. Provisional Application No. 63/459,809, filed on Apr. 17, 2023, the contents of which are incorporated herein by reference.

### TECHNICAL FIELD

The present disclosure relates generally to apparatuses, non-transitory machine-readable media, and methods associated with training an artificial neural network for generating mean time to failure predictions.

### BACKGROUND

A computing device can be, for example, a personal laptop computer, a desktop computer, a smart phone, smart glasses, a tablet, a wrist-worn device, a mobile device, a digital camera, and/or redundant combinations thereof, among other types of computing devices.

Computing devices can be used to perform operations. Performing operations can utilize resources of the computing devices. Performing operations can utilize memory resources, processing resources, and power resources, for example. Utilizing resources of the computing device can cause the computing devices to age. The computing devices can be retired based on the computing device's age. Retiring the computing devices can limit the errors experiences by the computing devices due to the age of the computing devices.

### BRIEF DESCRIPTION OF THE DRAWINGS

FIG. 1 illustrates an example computing system for training an artificial neural network in accordance with some embodiments of the present disclosure.

FIG. 2 is a functional block diagram of a system for training a device physics approximator in accordance with some embodiments of the present disclosure.

FIG. 3 is a functional block diagram of a system for training a device ageing approximator in accordance with some embodiments of the present disclosure.

FIG. 4 is a functional block diagram of a system for storing mean time to failure predictions for training an artificial neural network in accordance with some embodiments of the present disclosure.

FIG. 5 is a flow diagram corresponding to a method for training artificial neural networks in accordance with some embodiments of the present disclosure.

FIG. 6 is a block diagram of an example computer system in which embodiments of the present disclosure may operate.

### DETAILED DESCRIPTION

Apparatuses, machine-readable media, and methods related to training an artificial neural network (ANN) for generating mean time to failure (MTTF) predictions are disclosed herein. A computing device can receive device design parameters, operation parameters, and/or throughput characteristics, also referred to herein as device throughput characteristics, corresponding to a device comprising a photonic accelerator. The throughput characteristics can be received from a physics solver. As used herein, a physics solver can comprise hardware, firmware, and/or software configured to generate characteristics of a throughput of the device comprising a photonic accelerator. Although the physics solver can be implemented as hardware, firmware, and/or software, the physics solver is implemented as software in the examples described herein. The computing device can generate throughput predictions utilizing the device design parameters, the operation parameters, and the ANN. The computing device can generate a loss gradient utilizing the device throughput characteristics and the throughput predictions. The computing device can train the ANN utilizing the loss gradient.

As used herein the device design parameters describe parameters of a device computed prior to implementing the device (e.g., at a time the device is designed). The parameters can include, for example, a temperature at which the device and/or a photonic accelerator is intended to function. The operation parameters include parameters of a device as measured during operation of the device. The device design parameters and the operation parameters can describe a same parameter or different parameters. For example, the device design parameters can describe a temperature at which a device is intended to function while the operation parameters describe a measured temperature at which a device operates.

The throughput characteristics can describe signal intensity and/or signal wavelength, among other device throughput characteristics. For example, a device throughput can be defined as a measure of how many units of information a device can process in an amount of time. The signal intensity and/or the signal wavelength of a device can contribute to the amount of information a device can process. The throughput predictions of a device can be predictions of the signal intensity and/or the signal wavelength, among other device throughput characteristic predictions.

As used herein an ANN can provide learning by forming probability weight associations between an input and an output. The probability weight associations can be provided by a plurality of nodes that comprise the ANN. The nodes together with weights, biases, and/or activation functions can be used to generate an output of the ANN based on the input to the ANN. A plurality of nodes of the ANN can be grouped to form layers of the ANN.

A physics solver can be used to generate device throughput characteristics corresponding to a device that comprises a photonic accelerator. In a number of embodiments, the physics solver can be implemented as software executed by a processor. The device throughput characteristics can be utilized to generate an MTTF prediction, which can be utilized to determine when to retire devices that comprise photonic accelerators.

The physics solver is a tool (e.g., software tool) designed to solve complex physics-based equations which define a system. Photonic systems deal with light-matter interactions, and as such utilize complex solutions of Maxwell's equations to understand how light behaves in the device specific geometry and the device material.

The physics solver can be computationally expensive and time consuming to perform operational characteristics analysis. For example, the physics soler can utilize a duration of time to generate the throughput characteristics that can make it cumbersome to generate the MTTF predictions, which may limit the ability to make decisions about a device's age and when to retire the device.

Aspects of the present disclosure address the above and other deficiencies by training ANNs to replace the physics solver and an MTTF heuristic. The MTTF heuristic can comprise hardware, software, and/or firmware configured to generate MTTF predictions. The MTTF heuristic can also be referred to as an MTTF heuristic device. An ANN can generate device throughput characteristics in less time than a physics solver can generate the device throughput characteristics, which can make MTTF predictions available for determining the age of a device and/or for making determinations regarding the device. The ANN used to replace the physics solver can be used to train a different ANN, which can be used to replace the MTTF heuristic, thereby simplifying the hardware, software, and/or firmware utilized to generate the MTTF predictions.

A device comprising a photonic accelerator can be an edge device. An edge device describes a device that has processing capabilities and that connects and/or exchanges data with other devices and systems over a communications network. For example, edge devices can include internet of things (IOT) devices and/or user equipment (UE). A UE can include hand-held devices such as a hand-held telephone and/or a laptop computer equipped with a mobile broadband adapter, among other possible devices. IOT devices can include devices that comprise sensors and which can exchange data collected from said sensors. IOT devices can include smart home devices such as thermostats and doorbells and/or wearable devices such as smart watches, among other possible IOT devices. Edge devices can also include drones, for example. In many instances, the device (e.g., edge device) comprising the photonic accelerator can be a power over ethernet (POE) device. The edge device can be an end node such as a camera.

As used herein, a photonic accelerator is hardware that accelerates specific categories of computing in the optical domain to address the growing demands for computing resources and capacity. Photonic accelerators can be utilized to perform matrix multiplication using a plane light conversion method, Mach-Zehnder interferometer method, and/or wavelength division multiplexing method, among others. The photonic accelerators can be utilized to process images captured by a camera, for example. The photonic accelerator can be a processing device.

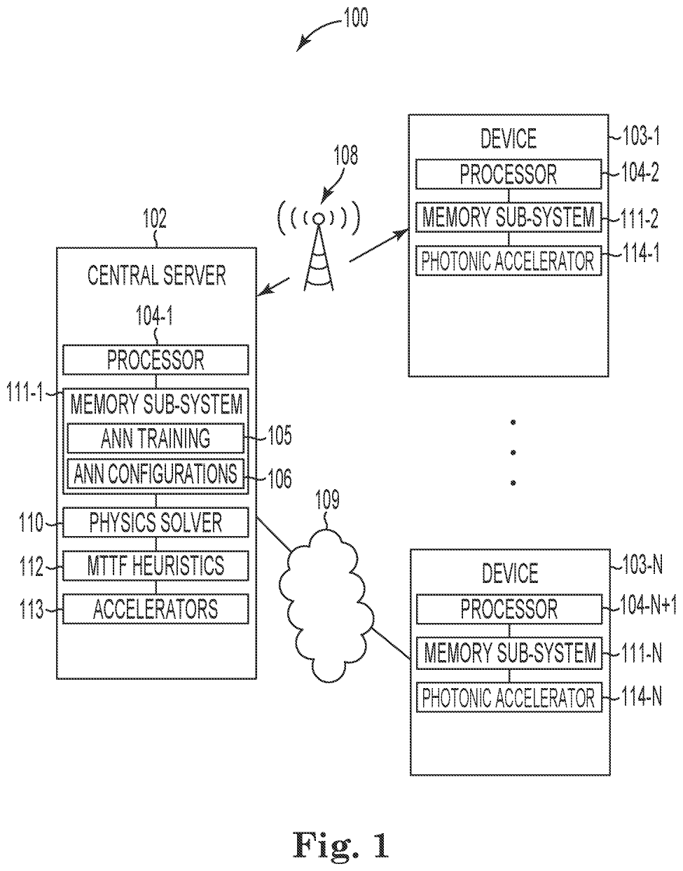

FIG. 1 illustrates an example computing system 100 for training an artificial neural network in accordance with some embodiments of the present disclosure. The computing system 100 can comprise a server 102 and devices 103-1, 103-N (e.g., devices 103-1, 103-N), referred to herein as devices 103.

The devices 103 can comprise hardware, firmware, and/or software configured to perform operations utilizing a photonic accelerator. The server 102 and the devices 103 can further include memory sub-systems 111-1, 111-2, 111-N+1 (e.g., a non-transitory MRM), referred to herein as memory sub-systems 111, on which may be stored instructions (e.g., instructions 105) and/or data (e.g., configurations 106). Although the following description refers to a processing device and a memory device, the description may also apply to a system with multiple processing devices and multiple memory devices. In such examples, the instructions may be distributed across (e.g., stored by) multiple memory devices and the instructions may be distributed across (e.g., executed by) multiple processing devices.

The memory sub-systems 111 may comprise memory devices. The memory devices may be electronic, magnetic, optical, or other physical storage device that stores executable instructions. One or both of the memory devices may be, for example, non-volatile or volatile memory. In some examples, one or both of the memory devices is a non-transitory MRM comprising RAM, an Electrically-Erasable Programmable ROM (EEPROM), a storage drive, an optical disc, and the like. The memory sub-systems 111 may be disposed within a controller, the server 102, and/or the devices 103. In this example, the instructions 105 can be “installed” on the server 102. The memory sub-systems 111 can be portable, external or remote storage mediums, for example, that allow the server 102 and/or the devices 103 to download the instructions 105 from the portable/external/remote storage mediums. In this situation, the instructions 105 may be part of an “installation package.” As described herein, the memory sub-systems 111 can be encoded with executable instructions (e.g., instructions 105) for training (e.g., ANN training instructions 105) and configuring (e.g., ANN configurations 106) an ANN to generate mean time to failure (MTTF) predictions.

The server 102 can execute the instructions 105 using the processor 104-1 and/or the accelerators 113. As used herein, the accelerators 113 can comprise hardware, firmware, or software configured to implement ANN's (e.g., ANN models). The instructions 105 can be stored in the memory sub-system 111-1 prior to being executed by the processing device 104-1. The execution of the instructions 105 can cause an ANN model to be trained and configured using the configurations 106. The ANN model can be utilized to configure the accelerators 113. The server 102 can control the accelerators 113 to cause the accelerators 113 to generate an MTTF prediction.

The server 102 can execute the instructions 105 using the processor 104-1 and/or the accelerators 113 to generate an MTTF prediction. The MTTF prediction can be generated in two stages. A first stage can generate device throughput characteristics and/or device throughput predictions. The device throughput characteristics and/or the device throughput predictions can be utilized in a second stage to generate an MTTF prediction.

In various instances, the physics solver 110 can be utilized to train, using the ANN instructions 105, a device physics approximator to generate device throughput predictions. The device physics approximator can be implemented utilizing the accelerators 113. For example, the device physics approximators can be an ANN that is implemented using the accelerators 113 to generate the device throughput predictions. The physics solver 110 can generate the device throughput characteristics and the device physics approximator can generate the device throughput predictions. The device throughput characteristics can be compared against the device throughput predictions to generate a loss gradient for backpropagation. Backpropagation can be performed utilizing the loss gradient to train the device physics approximator.

The device physics approximator can be executed in less time and/or utilizing less resources than the execution of the physics solver 110. The device physics approximator can be utilized to generate the device throughput predictions which can allow for the physics solver 110 not to be utilized. The device physics approximator can generate device throughput predictions while being trained, but can generate device throughput characteristics after the device physics approximator is deployed. The use of “predictions” in the device throughput predictions is meant to portray that the output of the physics solver 110 is the true output and the output of the device physics approximator is the prediction.

The device physics approximator can be utilized to train a device ageing approximator using the ANN instructions 105. The ANN instructions 105 can be used to train the device physics approximator and/or the device ageing approximator. In various instances, the ANN instructions 105 can include multiple sets of instructions that are combined into a single set of instructions or that are separate sets of instructions. The instructions to train the device physics approximator are different and distinct from the instruction utilized to train the device ageing approximator.

As used herein, the device ageing approximator can be implemented as an ANN. The device ageing approximator can be implemented in the accelerator 113. The weights, biases, and/or activation functions, among other variables that can be utilized to implement the device physics approximator and the device ageing approximator can be stored as the ANN configurations 106.

Traditionally, the physics solver 110 is utilized to generate device throughput characteristics, which are provided to an MTTF heuristic 112. The MTTF heuristic 112 can comprise hardware, firmware, or software that is utilized to generate an MTTF prediction utilizing the device throughput characteristics. In various instances, the MTTF heuristic 112 can comprise software that is executed by the processor 104-1 to generate MTTF predictions utilizing the device throughput characteristics.

In a number of embodiments, the device physics approximator can provide the device throughput characteristics (e.g., throughput predictions) to the MTTF heuristic 112. The MTTF heuristic 112 can utilize the device throughput characteristics provided by the physics approximator to generate the MTTF prediction. The MTTF prediction generated by the MTTF heuristic 112 can also be utilized to train the device ageing approximator. For example, the device ageing approximator can receive the device throughput characteristics from the device physics approximator and can generate an MTTF prediction.

The MTTF predictions generated by the MTTF heuristic 112 and the device ageing approximator can be utilized to train the device ageing approximator. For example, the MTTF predictions can be utilized to perform back propagation to update the ANN configurations 106 corresponding to the device ageing approximator.

In various examples, the MTTF prediction, the device design parameters, the operation parameters, the device throughput characteristics, and the device throughput predictions can correspond to the devices 103-1, 103-N, referred to herein as devices 103. For example, the device physics approximator and the device ageing approximator can receive the device design parameters and the operation parameters (e.g., device operation parameters) corresponding to the devices 103 and can generate an MTTF prediction for the devices 103. The device design parameters can be the same for multiple devices of the devices 103 if the multiple devices are of a same type (e.g., make and model).

Device operation parameters for each of the devices 103 can be provided to the server 102. The device 103-1 can provide a first number of device operation parameters while the device 103-N provides a second number of device operation parameters. The device physics approximator and the device ageing approximator can utilize the first number of device operation parameters and the device design parameters to generate a first MTTF prediction. The device physics approximator and the device ageing approximator can utilize the second number of device operation parameters and device design parameters to generate a second MTTF prediction. The first MTTF prediction can be a prediction for the device 103-1 while the second MTTF prediction can be a prediction for the device 103-N.

In various instances, the devices 103 can provide their corresponding operation parameters to the server 102 utilizing a wireless network 108 and/or a physical network 109. In various instances, the devices 103 can also provide device design parameters to the server 102. The server 102 can also access the device design parameters after identifying the devices 103.

The devices 103 can comprise the photonic accelerators 114-1, 114-N. The devices 103 can perform measurements to generate the device operation parameters. The edge devices 103, comprising the processors 104-2, 104-N+1, can cause the device operation parameters to be generated.

In various examples, the processors 104 can be internal to the memory sub-systems 111 instead of being external to the memory sub-systems 111 as shown. For instance, the processors 104 can be processor in memory (PIM) processors. The processors 104 can be incorporated into the sensing circuitry of the memory sub-systems 111 and/or can be implemented in the periphery of the memory sub-systems 111, for instance. The processors 104 can be implemented under one or more memory arrays of the memory sub-systems 111.

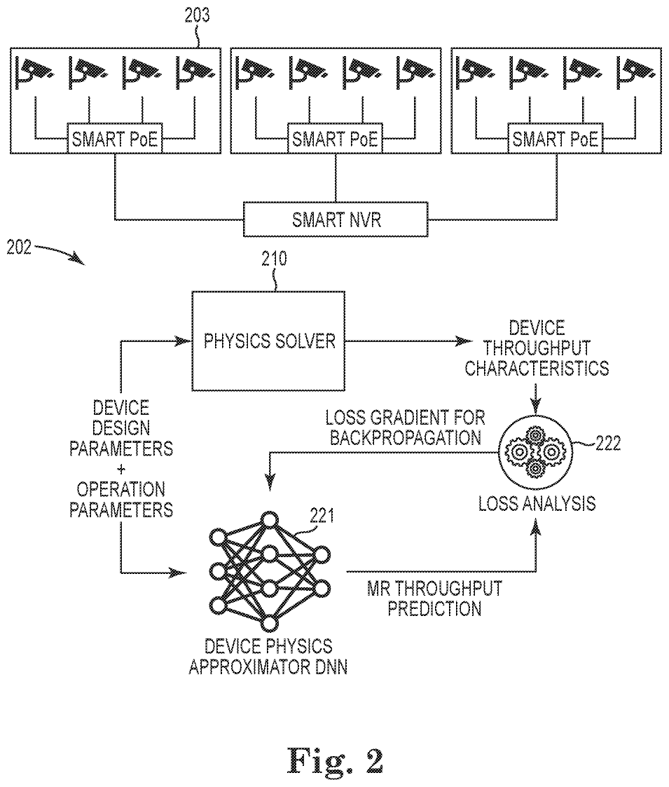

FIG. 2 illustrates a block diagram for training a device physics approximator 221 in accordance with some embodiments of the present disclosure. FIG. 2 shows a server 202 comprising a physics solver 210 and a device physics approximator 221. FIG. 2 also shows devices 203.

The devices 203 can comprise a photonic accelerator. The devices 203 can be coupled to a network video recorder (NVR). The devices 203 can be grouped utilizing power over ethernet (POE) devices. The PoE devices can be coupled to the NVR device such that the devices 203 are coupled to the NVR device through the PoE devices. Although FIG. 2 shows the devices 203 being coupled to the NVR device via the PoE devices, the devices 203 can be coupled directly to the NVR device. The PoE devices can provide power to the devices 203 and can route the signals provided by the devices 203 to the NVR device. The NVR device can store the signals provided by the devices 203 to record data (e.g., video data) provided by the devices 203.

The PoE devices and/or the NVR device can be referred to herein as smart devices given that the PoE devices and/or the NVR devices can be utilized to gather the device operation parameters of the devices 203. For instance, the PoE devices and/or the NBR device can request the device operation parameters from the devices 203. Upon receipt of the device operation parameters from the devices 203, the PoE device and/or the NVR device can provide the device operation parameters to the server 202. The PoE devices and/or the NVR device can gather the device operation parameters for training purposes and/or for generating an MTTF prediction for the devices 203.

The server 202, in addition to receiving the device operation parameters, can access the device design parameters. The server 202 can have previously stored the device design parameters in a memory subsystem of the server 202.

The server 202 can provide the device design parameters and/or the device operation parameters to the physics solver 210 and/or the device physics approximator 221. The physics solver 210 can be implemented as software executed by a processor while the device physics approximator is implemented as an ANN via an accelerator (e.g., accelerator 113 of FIG. 1) of the server 202 and/or a processing resource (e.g., processor 104-1 of FIG. 1) of the server 202.

In various examples, the physics solver 210 and the device physics approximator 221 can receive the device design parameters and/or the device operation parameters concurrently. As used herein, concurrence describes a same time or relatively a same time. The physic solver 210 and the device physics approximator 221 can receive the device design parameters and/or the device operation parameters at a same time or at relatively the same time.

In other examples, the physics solver 210 and the device physics approximator 221 can receive the device design parameters and the device operation parameters at different times. For example, the physics solver 210 can receive the device design parameters and the device operation parameters prior to the device physics approximator 221 receiving the device design parameters and the device operation parameters. The physics solver 210 can receive the device design parameters and the device operation parameters because the physics solver 210 can take longer to generate the device throughput characteristics than the amount of time the device physics approximator 221 takes to generate the device throughput prediction(s).

Although the physics solver 210 and the device physics approximator 221 are shown as being implemented in the server 202, the physics solver 210 and the device physics approximator 221 can be implemented in different devices and/or at different times. For example, the physics solver 210 can be implemented in a first device while the device physics approximator 221 is implemented in a second device. The physics solver 210 can be implemented in a first device at a first time while the device physics approximator 221 is implemented in a second device at a second time, where the first time and the second time are different times. As used herein, implementing a physics solver 210 and/or the device physics approximator 221 can include configuring the physics solver 210 and/or the device physics approximator and/or executing the physics solver 210 and/or the device physics solver to generate the device throughput characteristics and/or the device throughput predictions, respectively.

The physics solver 210 can generate the device throughput characteristics utilizing the device design parameters and/or the device operation parameters. The device physics approximator 221 can generate the device throughput prediction utilizing the device design parameters and/or the operation parameters. A processing device (e.g., processor) of the server 202 can perform a loss analysis 222 utilizing the device throughput characteristics and the device throughput prediction. The loss analysis 222 can be, for example, a backpropagation. The processing device of the server 202 can perform backpropagation to compute the gradient (e.g., loss gradient) of the loss function. For instance, the processing device can perform backpropagation to compute the loss gradient of the loss function with respect to each weight of the device physics approximator 221. The loss gradient can be determined one layer at a time (e.g., for each layer of the device physics approximator 221) iteratively backwards from a first layer of the device physics approximator 221.

The loss gradient represents the error between an estimate (e.g., device throughput predictions) and a true value (e.g., device throughput characteristics). The loss gradient can be used to update the weights of the device physics approximator 221. In various instances, the processing resource of the system 202 can perform the backpropagation using the loss gradient computed using the loss function to update the weights of the device physics approximator 221. The processing resource of the system 202 can generate the loss function to generate the loss gradient. In various instances, the loss function and the backpropagation can be performed by different devices. Updating the weights of the device physics approximator 221 can constitute training the device physics approximator 221. Once the device physics approximator 221 is trained, the device physics approximator 221 can be utilized to generate the device throughput characteristics instead of relying on the physics solver 210 to generate the device throughput characteristics. For example, the device physics approximator 221 can generate the device throughput characteristics for the purposes of training the device ageing approximator or for the purposes of generating an MTTF prediction to determine an action to carry out based on the age of the devices (e.g., edge devices).

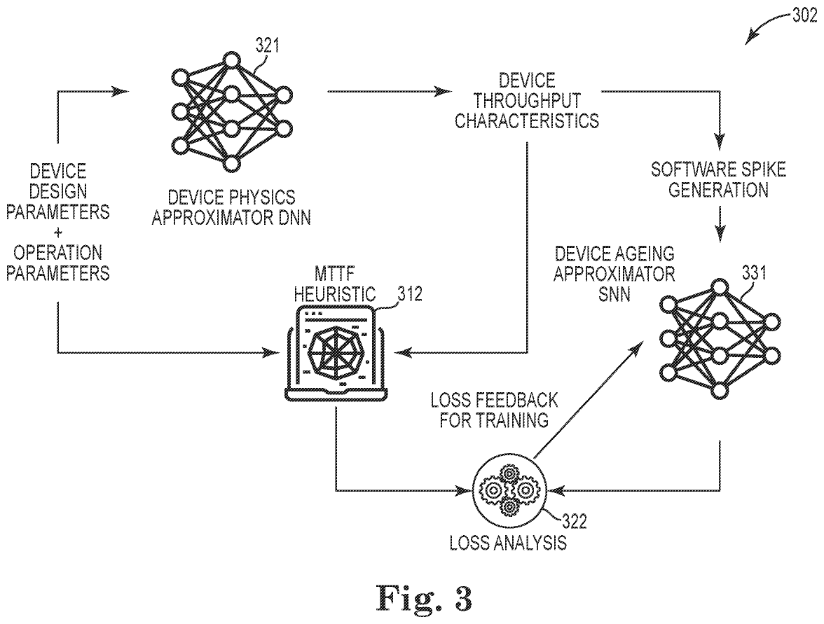

FIG. 3 illustrates a block diagram for training a device ageing approximator 331 in accordance with some embodiments of the present disclosure. FIG. 3 includes a device physics approximator 321, a device ageing approximator 331, and an MTTF heuristic 312.

The device physics approximator 321 can replace the physics solver to provide the device throughput characteristics to the MTTF heuristic 312. The device physics approximator 321 can receive the device design parameters and/or the device operation parameters. For example, the device physics approximator 321, being implemented in an accelerator of the system 302 as an ANN, can receive the device design parameters and the device operation parameters from a processing resource of the system 302. The processing resource of the system 302 can access the device design parameters and the device operation parameters from a memory sub-system. The device design parameters and/or the device operation parameters can be analogous to the device design parameters and/or the device operation parameters described with regards to FIG. 2.

The device throughput characteristics generated by the device physics approximator 321 can be provided to a processing resource and/or a memory sub-system. The processing resource can retrieve the device throughput characteristics and can provide the device throughput characteristics, the device design parameters, and/or the device operation parameters to the MTTF heuristic 312. The MTTF heuristic 312 can utilize the device throughput characteristics, the device design parameters, and/or the device operation parameters to generate an MTTF prediction.

The device physics approximator 321 can also provide the device throughput characteristics to the device ageing approximator 331. The device physics approximator 321 can provide the device throughput characteristics directly or indirectly to the device ageing approximator 331. The device physics approximator 321 can indirectly provide the device throughput characteristics to the device ageing approximator 331 via the processing resource of the system 302. In various instances, the device ageing approximator 321 can also receive the device design parameters and/or device operation parameters concurrently with the receipt of the device throughput characteristics. The device ageing approximator 321 can generate a different MTTF prediction using at least the device throughput characteristics.

The loss analysis 322 can be performed by a processing resource of the system 302. The loss analysis 322 can be performed to generate loss feedback for training similar to the backpropagation performed in FIG. 2 to train the device physics approximator 221 of FIG. 2. For example, performing the loss analysis 322 can include generating feedback on the difference between the MTTF prediction generated by the MTTF heuristic 312 and the MTTF prediction generated by the device ageing approximator 331. The loss analysis 322 can compare the MTTF prediction generated by the MTTF heuristic 312 and the MTTF prediction generated by the device ageing approximator 331. The loss feedback can be utilized to train the device ageing approximator 331. The device ageing approximator 331 can be utilized to replace the MTTF heuristic 312. A benefit of replacing the MTTF heuristic 312 with the device ageing approximator 331 is that the device ageing approximator 331 does not need to receive the device design parameters and/or the operation parameters.

The device physics approximator 321 and/or the device ageing approximator 331 can be implemented as ANNs. The type of ANN used to implement the device physics approximator 321 and/or the device ageing approximator 331 can be based on a format of the input and/or a format of the output of the device physics approximator 321 and/or the device ageing approximator 331. The device physics approximator 321 can be implemented as a deep neural network (DNN) while the device ageing approximator 331 can be implemented as a spiking neural network (SNN). As used herein, a DNN describes a neural network comprising multiple layers between an input layer and an output layer. A SNN describes a neural network where the cells are activated using signals provided by a previous layer of cells.

In various instances, the device design parameters and the device operation parameters can be in a digital format. The device throughput characteristics can be in a digital format. The device throughput characteristics can be converted from a digital format to an analog format. The device ageing approximator 331 can receive inputs in the analog format. The device throughput characteristics can be converted to an analog format utilizing a spike generator that can be implemented as software. The spike generator can be executed by the processing resource (e.g., CPU) of the server 302.

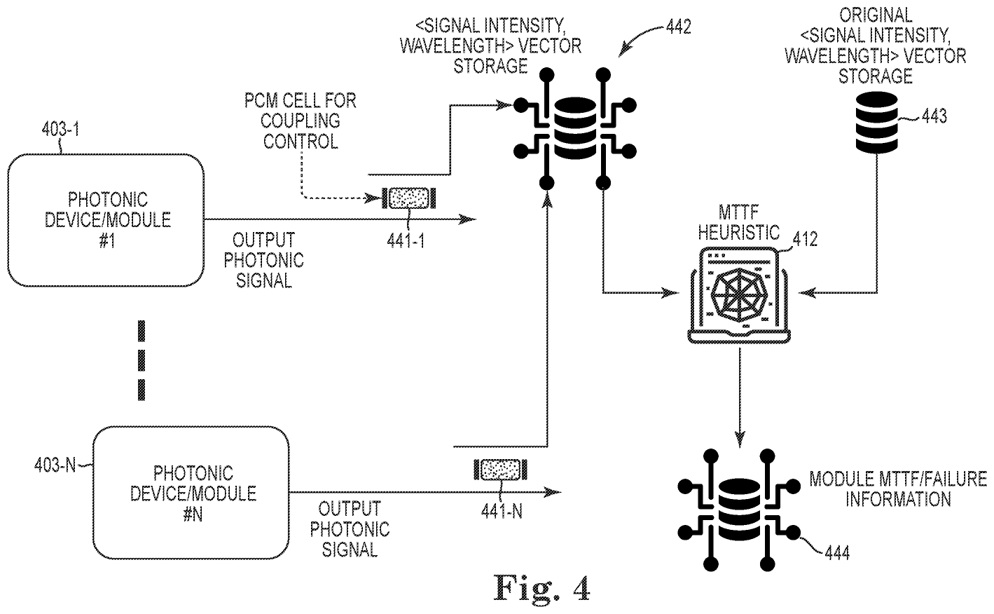

FIG. 4 illustrates a block diagram for storing mean time to failure predictions for training an artificial neural network in accordance with some embodiments of the present disclosure. FIG. 4 includes devices 403-1, 403-N, referred to as devices 403. FIG. 4 also includes phase changing material (PCM) cells 441-1, 441-N, databases 442, 443, 444, and MTTF heuristic 412. The MTTF heuristic 412 can generate MTTF predictions (e.g., module MTTF/failure information) which can be stored in the database 444. The MTTF predictions can be stored in the database 444 to be used at a later time to train the device ageing approximator.

The devices 403 can be photonic devices and/or modules. The photonic devices and/or modules can describe devices and/or modules that comprise a photonic accelerator. The devices 403 can output photonic signals that the PCM cells can store. The PCM cells can be utilized to provide the photonic signals read from the PCM cells to the processing resource (e.g., controller). The processing resource can perform measurements on the photonic signals to determine a signal intensity and/or wavelength (e.g., device operation parameters), among other device operation parameters that can be generated.

The device operation parameters can be stored in the database 442 (e.g., vector storage) to allow the MTTF heuristic 412 to utilize the operation device parameters at a convenient time. The database 443 can store the device design parameters (e.g., original signal intensity and/or original signal strength). The database 443 may not change once the device design parameters are stored because the device design parameters do not change over time. The device operation parameters can change over time for the devices 403 such that the database 442 is updated over time.

The MTTF heuristic 412 can generate an MTTF prediction from the device design parameters and/or the device operation parameters. The MTTF prediction can be stored in the database 444 to allow for a convenient use of the MTTF prediction to train the device ageing approximator.

Although not shown, the device ageing approximator can be utilized to generate MTTF predictions in a similar manner to which the MTTF heuristic is utilized. For example, once the device ageing approximator is trained, the device ageing approximator can be utilized to generate MTTF predictions. The server can provide the device throughput characteristics to the device ageing approximator. The device throughput characteristics can be stored in a database prior to being provided to the device ageing approximator similar to how the device operation parameters are stored in the database 442 prior to being provided to the MTTF heuristic 412. The device ageing approximator can generate MTTF predictions utilizing the device throughput characteristics. The MTTF predictions can be stored in a different database to allow for a convenient use of the MTTF predictions. The MTTF predictions can be utilized to determine how to best utilize the devices 403. For example, the MTTF predictions can be utilized to determine when to retire the devices 403 or to determine when to take other actions to minimize an impact from a possible failure of the devices 403.

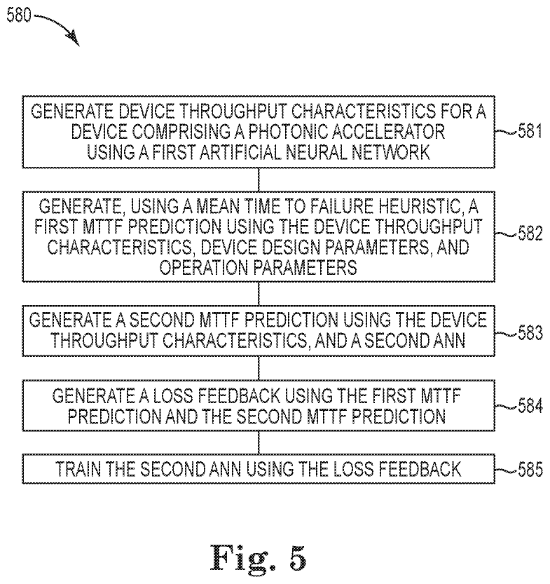

FIG. 5 is a flow diagram corresponding to a method 580 for training artificial neural networks in accordance with some embodiments of the present disclosure. The method 580 may be performed, in some examples, using a computing system such as those described with respect to FIG. 1. The method 580 can be used to train an ANN.

At 581, device throughput characteristics can be generated for a device comprising a photonic accelerator using a first ANN. The first ANN can be referred to as a device physics approximator. At 582, a first MTTF prediction can be generated by an MTTF heuristic using the device throughput characteristics, device design parameters, and/or operation parameters. In various instances the MTTF heuristic can comprise hardware, software, and/or firmware configured to generate an MTTF prediction.

At 583, a second MTTF prediction can be generated using the device throughput characteristics. The second MTTF prediction can be generated by a second ANN. The second ANN can be referred to as a device ageing approximator. At 584, the first MTTF and the second MTTF can be utilized to generate a loss feedback. For example, the first MTTF and the second MTTF can be compared against each other to determine an error which can be utilized as the loss feedback to train the second ANN. At 585, the loss feedback can be used to train the second ANN. In various instances, the processing resource of the system can generate the loss feedback and can utilize the loss feedback to train the device ageing approximator.

The first ANN can be a DNN. The first ANN can receive the device design parameters and/or the operation parameters which can be in a digital format. The second ANN can be a SNN which can receive the device throughput characteristics in an analog format. The device throughput characteristics can be provided from the first ANN in a digital format prior to being converted to an analog format prior to being received by the second ANN.

In various examples, a processing resource can be configured to receive device design parameters and operation parameters corresponding to a device. The device can be a different separate from the processing resource. The processing resource can also receive device throughput characteristics from a physics solver. The physics solver can be implemented in a same device (e.g., system) that comprises the processing resource or a separate device that does not comprise the processing resource. The processing resource can generate device throughput predictions utilizing the device design parameters, the operation parameters, and an ANN. The ANN can be referred to as a device physics approximator.

The processing resource can generate a loss gradient utilizing the device throughput characteristics and the device throughput predictions. The loss gradient can be generated by comparing the device throughput predictions and the device throughput characteristics. The device throughput predictions are also referred to herein as throughput predictions. The processing resource can train the ANN, utilizing the loss gradient, to generate different device throughput predictions.

The device design parameters can include a designed signal intensity and/or designed wavelength, among other device design parameters. The operation parameters can include an operating signal intensity and/or an operating wavelength. The device design parameters and the operation parameters can correspond to the device comprising a photonic accelerator.

The physics solver can receive the design parameters and/or the operation parameters. The design parameters and the operation parameters can be concurrently received by the physics solver and the processing device. The physics solver can generate the device throughput characteristics using the design parameters and the operation parameters. The physics solver can provide the device throughput characteristics to the processing device.

In various examples, device throughput characteristics can be generated using a first ANN, where the device throughput characteristics correspond to a device comprising a photonic accelerator. The device throughput characteristics can be stored in memory. An MTTF heuristic can generate a first MTTF prediction using the device throughput characteristics, operation parameters, and device design parameters. The operation parameters can be accessed from a memory and the device design parameters can be accessed from a different memory. The first MTTF prediction, the device design parameters, and/or the operation parameters can correspond to the device comprising the photonic accelerator. The first MTTF can be stored in the memory to make the first MTTF prediction available to train a second ANN.

A second MTTF prediction can be generated using the device throughput characteristics accessed from the memory and the second ANN. For example, the second ANN can generate the second MTTF prediction utilizing the device throughput characteristics. A loss feedback can be generated using the first MTTF prediction accessed from memory and the second MTTF prediction. The second ANN can be trained using the loss feedback. For example, weights of the second ANN can be adjusted using the loss feedback. The trained second ANN can be executable by a different computer to generate a different MTTF prediction for a different device comprising a different photonic accelerator.

The plurality of device throughput characteristics including the device throughput characteristics and/or a plurality of operation parameters including the operation parameters can be stored. The plurality of device throughput characteristics and the plurality of operation parameters can correspond to a plurality of different devices.

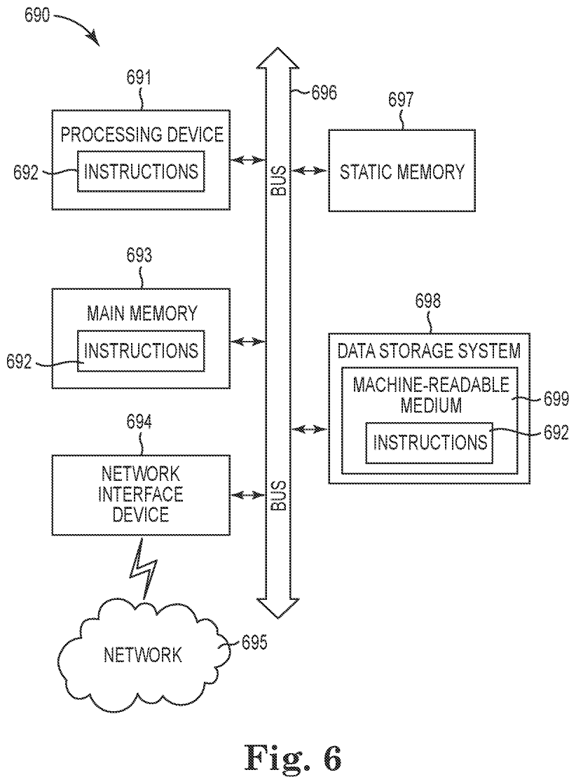

FIG. 6 is a block diagram of an example computer system 690 in which embodiments of the present disclosure may operate. For example, FIG. 6 illustrates an example machine of a computer system 690 within which a set of instructions, for causing the machine to perform any one or more of the methodologies discussed herein, can be executed. In some embodiments, the computer system 690 can correspond to a host system that includes, is coupled to, or utilizes a memory sub-system (e.g., the memory sub-systems 111-1, 111-2, 111-N+1 of FIG. 1). The computer system 690 can be used to perform the operations described herein (e.g., to perform operations corresponding to the processors 104-1, 104-2, 104N+1 of FIG. 1). In alternative embodiments, the machine can be connected (e.g., networked) to other machines in a LAN, an intranet, an extranet, the Internet, and/or wireless network. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 690 includes a processing device (e.g., processor) 691, a main memory 693 (e.g., read-only memory (ROM), flash memory, dynamic random access memory (DRAM) such as synchronous DRAM (SDRAM) or Rambus DRAM (RDRAM), etc.), a static memory 697 (e.g., flash memory, static random access memory (SRAM), etc.), and a data storage system 698, which communicate with each other via a bus 696.

The processing device 691 represents one or more general-purpose processing devices such as a microprocessor, a central processing unit, or the like. More particularly, the processing device 691 can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 691 can also be one or more special-purpose processing devices such as an application specific integrated circuit (ASIC), a field programmable gate array (FPGA), a digital signal processor (DSP), network processor, or the like. The processing device 691 is configured to execute instructions 692 for performing the operations and steps discussed herein. The computer system 690 can further include a network interface device 694 to communicate over the network 695.

The data storage system 698 can include a machine-readable storage medium 699 (also known as a computer-readable medium) on which is stored one or more sets of instructions 692 or software embodying any one or more of the methodologies or functions described herein. The instructions 692 can also reside, completely or at least partially, within the main memory 693 and/or within the processing device 691 during execution thereof by the computer system 690, the main memory 693 and the processing device 691 also constituting machine-readable storage media. The machine-readable storage medium 699, data storage system 698, and/or main memory 693 can correspond to the memory sub-systems 111-1, 111-2, 111-N+1 of FIG. 1.

In one embodiment, the instructions 692 include instructions to implement functionality corresponding to examples described herein (e.g., using processors 104-1, 104-2, 104-N+1 of FIG. 1). While the machine-readable storage medium 699 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus comprising:
a processing device configured to:
receive device design parameters corresponding to a device;
receive operation parameters corresponding to the device;
receive device throughput characteristics from a physics solver;
generate device throughput predictions utilizing the device design parameters, the operation parameters, and an artificial neural network;
generate a loss gradient utilizing the device throughput characteristics and the device throughput predictions; and
train the artificial neural network, utilizing the loss gradient, to generate different device throughput predictions.

2. The apparatus of claim 1, wherein the device design parameters include a designed signal intensity.

3. The apparatus of claim 1, wherein the device design parameters include a designed wavelength.

4. The apparatus of claim 1, wherein the operation parameters include an operating signal intensity.

5. The apparatus of claim 1, wherein the operation parameters include an operating wavelength.

6. The apparatus of claim 1, wherein the device design parameters and the operation parameters correspond to the device comprising a photonic accelerator.

7. The apparatus of claim 1, wherein the processing device is further configured to generate the loss gradient by comparing the device throughput characteristics and the device throughput predictions.

8. The apparatus of claim 1, wherein the physics solver comprises machine-readable instructions executable generate the device throughput characteristics.

9. The apparatus of claim 1, wherein the physics solver is configured to:
receive the design parameters; and
receive the operation parameters, wherein the design parameters and the operation parameters are concurrently received by the physics solver and the processing device.

10. The apparatus of claim 9, wherein the physics solver is further configured to:
generate the device throughput characteristics using the design parameters and the operation parameters; and
provide the device throughput characteristics to the processing device.

11. A method, comprising:
generating device throughput characteristics for a device comprising a photonic accelerator using a first artificial neural network (ANN);
generating, using a mean time to failure (MTTF) heuristic, a first MTTF prediction using the device throughput characteristics, device design parameters, and operation parameters;
generating a second MTTF prediction using the device throughput characteristics, and a second ANN;
generating a loss feedback using the first MTTF prediction and the second MTTF prediction; and
training the second ANN using the loss feedback.

12. The method of claim 11, wherein the first ANN is a deep neural network.

13. The method of claim 12, further comprising receiving, at the deep neural network, the device design parameters and the operation parameters, which are in a digital format.

14. The method of claim 13, wherein the second ANN is a spiking neural network.

15. The method of claim 14, further comprising receiving, at the spiking neural network, the device throughput characteristics in an analog format.

16. The method of claim 15, further comprising converting the device throughput characteristics to the analog format utilizing a software spike generator.

17. A non-transitory machine-readable medium having computer-readable instructions, which when executed by a computer, cause the computer to:
generate device throughput characteristics using a first artificial neural network (ANN), wherein the device throughput characteristics correspond to a device comprising a photonic accelerator;
store the device throughput characteristics in memory;
generate, using a mean time to failure (MTTF) heuristic, a first MTTF prediction using the device throughput characteristics, and operation parameters, accessed from the memory and device design parameters accessed from a different memory, wherein the first MTTF prediction, the device design parameters, and the operation parameters correspond to the device comprising the photonic accelerator; and
store the first MTTF prediction in the memory to make the first MTTF prediction available to train a second ANN.

18. The machine-readable medium of claim 17, wherein the instructions are further executable to generate a second MTTF prediction using the device throughput characteristics accessed from the memory and the second ANN.

19. The machine-readable medium of claim 18, wherein the instructions are further executable to generate a loss feedback using the first MTTF prediction accessed from memory and the second MTTF prediction.

20. The machine-readable medium of claim 19, wherein the instructions are further executable to train the second ANN using the loss feedback.

21. The machine-readable medium of claim 20, wherein the trained second ANN is executable by a different computer to generate a different MTTF prediction for a different device comprising a different photonic accelerator.

22. The machine-readable medium of claim 17, wherein the instructions are further executable to store a plurality of device throughput characteristics including the device throughput characteristics and a plurality of operation parameters including the operation parameters, wherein the plurality of device throughput characteristics and the plurality of operation parameters correspond to a plurality of different devices.
